(19) United States
(12) Patent Application Publication
(10) Pub. No.: US 2026/0133756 A1
(43) Pub. Date: May 14, 2026

(54) ELECTRONIC DEVICE FOR EXECUTING VOICE RECOGNITION FUNCTION, OPERATING METHOD THEREOF, AND STORAGE MEDIUM

(71) Applicant: Samsung Electronics Co., Ltd., Suwon-si (KR)

(72) Inventor: Eunkyung LEE, Suwon-si (KR)

(21) Appl. No.: 19/443,773

(22) Filed: Jan. 8, 2026

Related U.S. Application Data
(63) Continuation of application No. PCT/KR2024/008937, filed on Jun. 27, 2024.

(30) Foreign Application Priority Data
Jul. 10, 2023 (KR) 10-2023-0089003
Sep. 22, 2023 (KR) 10-2023-0127333

(51) Int. Cl. G06F 3/16; G06F 3/0481

(52) U.S. Cl. CPC G06F 3/167; G06F 3/0481

(57) ABSTRACT

An electronic device is provided. The electronic device includes a display, memory, comprising one or more storage media, storing instructions, and at least one processor operatively connected to the display and the memory, wherein the instructions, when executed by the at least one processor individually or collectively, cause the electronic device to display a window of an application, detect a user selection for displaying an input interface for the window, in response to the user selection, compare the size of the window or the input interface to a specified size, and execute one of a display of the input interface or voice recognition function according to a result of the comparison.

### CROSS-REFERENCE TO RELATED APPLICATION(S)

This application is a continuation application, claiming priority under 35 U.S.C. § 365(c), of an International application No. PCT/KR2024/008937, filed on Jun. 27, 2024, which is based on and claims the benefit of a Korean patent application number 10-2023-0089003, filed on Jul. 10, 2023, in the Korean Intellectual Property Office, and of a Korean patent application number 10-2023-0127333, filed on Sep. 22, 2023, in the Korean Intellectual Property Office, the disclosure of each of which is incorporated by reference herein in its entirety.

### BACKGROUND

### 1. Field

The disclosure relates to an electronic device for executing a speech recognition function, an operation method thereof, and a storage medium.

### 2. Description of Related Art

Various services and additional functions provided through electronic devices such as smartphones are gradually increasing. In order to increase the utility value of such electronic devices and satisfy the demands of various users, communication service providers or electronic device manufacturers are competitively developing electronic devices so as to provide various functions and differentiate from other companies. Accordingly, various functions provided through the electronic devices are being increasingly advanced.

For example, such electronic devices have a virtual keyboard formed on a display, and provide a speech recognition function for recognizing a user's speech and inputting text, in addition to a text input method through the keyboard.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for executing a speech recognition function, an operation method thereof, and a storage medium.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, comprising one or more storage media, storing instructions, and at least one processor operatively connected to the display, and the memory, wherein the instructions, when executed by the at least one processor individually or collectively, cause the electronic device to display a window of an application, detect a user selection for displaying the input interface for the window, in response to the user selection, compare the size of the window or the input interface with a specified size, and execute one of display of the input interface or a speech recognition function according to a result of the comparison.

In accordance with another aspect of the disclosure, a method for executing a speech recognition function performed by an electronic device is provided. The method includes displaying a window of an application, detecting a user selection for displaying an input interface for the window, in response to the user selection, comparing the size of the window or the input interface with a specified size, and based on a result of the comparison, executing one of a display of the input interface and the speech recognition function.

In accordance with another aspect of the disclosure, a non-transitory computer-readable storage medium storing instructions that, when executed by at least one processor of an electronic device individually or collectively, cause the electronic device to perform operations are provided. The operations include displaying a window of an application, detecting a user selection for displaying the input interface for the window, in response to the user selection, comparing the size of the window or the input interface with a specified size, and based on a result of the comparison, executing one of a display of the input interface and a speech recognition function.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 illustrates a screen on which a keyboard is displayed in response to a text input request according to an embodiment of the disclosure;

FIG. 3 is a block diagram illustrating an internal configuration of an electronic device according to an embodiment of the disclosure;

FIG. 4 is a flowchart illustrating operations of an electronic device for executing a speech recognition function according to an embodiment of the disclosure;

FIG. 5 illustrates a screen when an input interface is called according to an embodiment of the disclosure;

FIG. 6 illustrates a screen when an input interface is called in a virtual reality space according to an embodiment of the disclosure;

FIG. 7 illustrates a screen on which a speech recognition function is executed instead of displaying an input interface when a specified application is being executed according to an embodiment of the disclosure;

FIG. 8A illustrates a screen on which an input item is input using a speech recognition function according to an embodiment of the disclosure;

FIG. 8B illustrates a screen following FIG. 8A according to an embodiment of the disclosure;

FIG. 9A illustrates a screen on which a speech recognition function is executed during text input through a widget when a specified application is being executed according to an embodiment of the disclosure;

FIG. 9B illustrates a screen following FIG. 9A according to an embodiment of the disclosure;

FIG. 10 is a flowchart illustrating operations for determining whether to execute a speech recognition function according to an embodiment of the disclosure;

FIG. 11 illustrates a screen indicating an input interface using a speech recognition function according to an embodiment of the disclosure;

FIG. 12A illustrates a screen indicating an input interface associated with a schedule function using a speech recognition function in a wearable electronic device according to an embodiment of the disclosure;

FIG. 12B illustrates a screen indicating an input interface associated with a message function using a speech recognition function in a wearable electronic device according to an embodiment of the disclosure;

FIG. 13 illustrates a screen on which a speech recognition function is executed based on a size of a display according to an embodiment of the disclosure;

FIG. 14A illustrates a screen on which a speech recognition function is executed when a size of an input target for which user input for an input item and text is possible in a virtual reality space is equal to or smaller than a threshold size according to an embodiment of the disclosure;

FIG. 14B illustrates a method of inputting an input item using a speech recognition function according to an embodiment of the disclosure;

FIG. 15 illustrates a screen on which a speech recognition function is executed when an input target for which user input for an input item and text is possible is covered by a virtual object according to an embodiment of the disclosure;

FIG. 16 illustrates a screen on which a speech recognition function is executed using a user gesture according to an embodiment of the disclosure;

FIG. 17A illustrates a screen on which a keyboard for text input is displayed according to an embodiment of the disclosure;

FIG. 17B illustrates a screen on which a speech recognition function is executed when an input target for which user input for an input item and text is possible is selected according to an embodiment of the disclosure;

FIG. 17C illustrates a screen on which a speech recognition function is executed when an input target for which user input for an input item and text displayed in a size smaller than a specified size is possible is selected according to an embodiment of the disclosure;

FIG. 18A illustrates a screen on which a speech recognition function is executed when a virtual reality space of an external electronic device is moved and executed in an electronic device according to an embodiment of the disclosure;

FIG. 18B illustrates a screen on which a speech recognition function for text input is executed when a situation requiring text input occurs in a virtual reality space of an electronic device according to an embodiment of the disclosure; and

FIG. 19 illustrates a screen on which a speech recognition function is executed when a size of an input target for which user input for an input item and text is possible is reduced to a threshold size according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

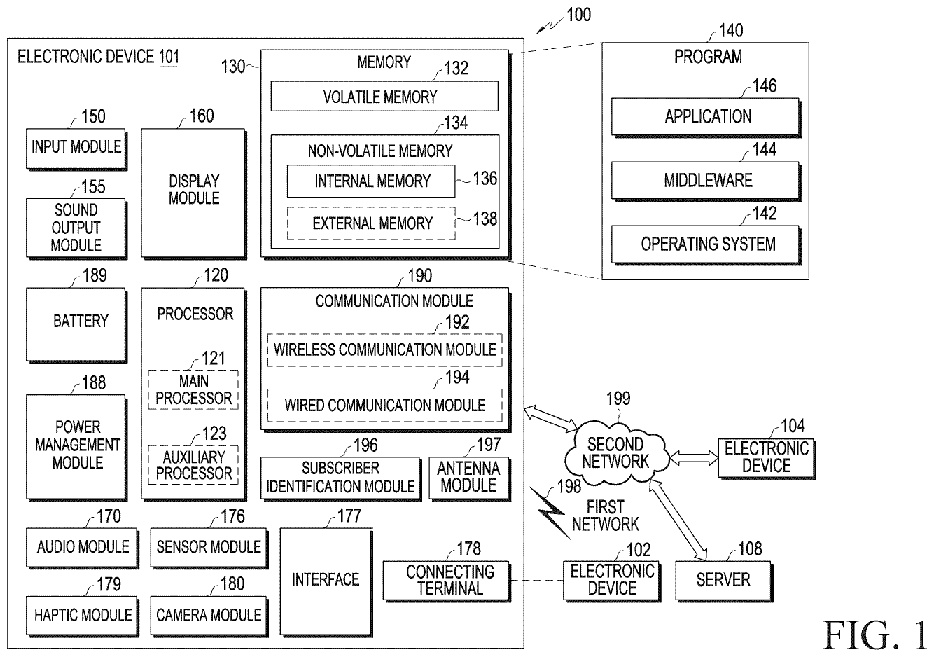

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the detailed description below, elements that can be easily understood through the preceding embodiments are assigned the same reference numerals or omitted from the drawings, and the detailed description thereof may also be omitted. The electronic device 101 according to an embodiment disclosed herein may be implemented through selective combination of elements of different embodiments, and an element of one embodiment may be replaced by an element of another embodiment. For example, the disclosure is not limited to a particular drawing or embodiment.

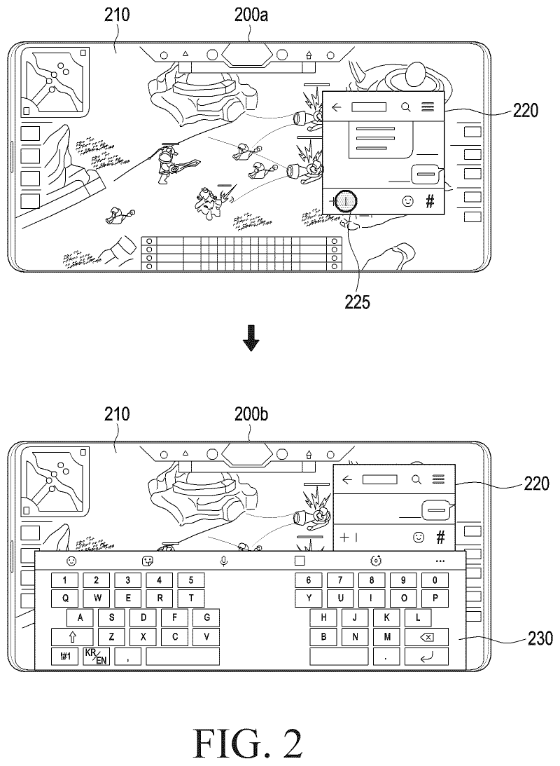

FIG. 2 illustrates a screen on which a keyboard is displayed in response to a text input request according to an embodiment of the disclosure.

Referring to FIG. 2, for example, it is common that when a user executes a function provided by another application while a main window (or execution screen) of an already-used application is displayed, a sub-window may be overlaid and fixed in a specific position that covers the main window of the currently displayed application.

As illustrated in 200a of FIG. 2, while windows (or execution screens) 210 and 220 of the running application are displayed, the electronic device may detect a user input 225 through the window (or execution screen) 220 of the application, which enables text input. Based on the user input 225 for text input, as illustrated in 200b of FIG. 2, the electronic device may call an input interface (e.g., a keyboard (or keypad)) 230 and display the same through a display. For example, when a user inputs text into a chat application, the user may input text in a specific area of the chat application by using the keyboard 230. Accordingly, the user may provide an input to the electronic device through the keyboard 230 while viewing content on the display of the electronic device. For example, the user may interact with a button or an icon displayed on the display, but may input text such as numbers, characters, symbols, or a combination thereof through the keyboard 230.

However, due to the keyboard 230 being called, the keyboard 230 may be displayed to partially cover the execution screen 210 or 220 of the application, regardless of the screen of the running application. In addition, in a case of an electronic device having a limited display size, key map areas that ensure a minimum touch area need to be included, and thus most of the execution screen 210 or 220 of the application may be covered due to the display of the keyboard 230. Accordingly, when the user is viewing content, the display of the keyboard 230 may be an obstacle to viewing.

Therefore, if the electronic device adaptively changes an input method for inputting a user input item such as text according to various situations, the user can more easily use the functions of the electronic device, whereby the user's convenience and satisfaction can be increased.

An embodiment may provide an electronic device for executing a speech recognition function to enable a user input such as text to be input without covering a screen of a running application when a user input for calling an input interface is detected, an operation method thereof, and a storage medium.

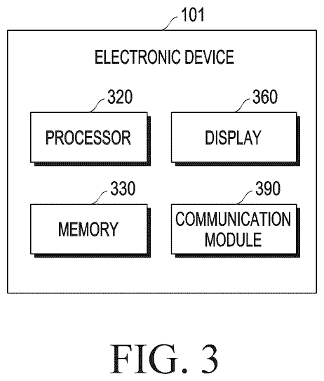

FIG. 3 is a block diagram illustrating an internal configuration of an electronic device according to an embodiment of the disclosure.

Referring to FIG. 3, an electronic device 101 (e.g., the electronic device 101 of FIG. 1 or the electronic device 101 of FIG. 2) according to an embodiment may include a processor 320 (e.g., the processor 120 of FIG. 1) and a display 360 (e.g., the display module 160 of FIG. 1). The electronic device 101 according to an embodiment may further include memory 330 (e.g., the memory 130 of FIG. 1) and/or a communication module 390 (e.g., the communication module 190 of FIG. 1). All elements illustrated in FIG. 3 are not essential elements of the electronic device 101, and the electronic device 101 may be implemented by more or fewer elements than the elements illustrated in FIG. 3.

The display 360 may not only support both input and output functions of data but also detect a touch. According to an embodiment, the display 360 may be referred to as a touch screen. The display 360 may include a sensing panel, and the sensing panel may detect that a finger or an input device (e.g., a stylus pen) has touched or approached. For example, the sensing panel may detect a hovering input by the input device, and may transfer an input signal corresponding to the hovering input to the processor 320 (e.g., the processor 120 of FIG. 1).

Two or more windows may be displayed on the display 360, and at least one of the two or more windows may be a sub window displayed as a window smaller than the area of the display 360. The sub-window is configured with an AOT function and may provide a view that is always disposed in a floating form above other windows. Hereinafter, a window displayed in the entire area of the display 360, which is not a sub-window displayed on the top among multiple windows, may be referred to as a main window. For example, the main window may include data generated while an application (or task) is executed, and may refer to an image output on the display 360 by an application performed in a foreground environment.

According to an embodiment, the memory 330 is electrically connected to the processor 320, and may store at least one application.

According to an embodiment, the memory 330 may store a control program for controlling the electronic device 101, a user interface (UI) related to an application provided by a manufacturer or downloaded from the outside, images for providing the UI, user information, documents, databases, or related data.

According to an embodiment, the memory 330 may store instructions for controlling the processor 320 to perform various operations when executed. According to an embodiment, the memory 330 may be operatively connected to the display 360 and the processor 320, and may store instructions configured to display a window of an application, detect a user selection for displaying an input interface for the window, in response to the user selection, compare a size of the window or the input interface with a specified size, and execute, based on a result of the comparison, one of a display of the input interface and the speech recognition function.

According to an embodiment, the processor 320 may execute at least one application in response to a user input. The processor 320 may display the execution screen of the application by using a main window (window) in a floating form to occupy the entire display 360. The main window may be defined as a predetermined space generated according to the execution of the application, and contents corresponding to the application may be visually output through the display 360. According to an embodiment, the main window may include a data object generated while the application is executed, for example, at least one of video data, audio data, or display information. Therefore, the main window may correspond to data related to the running application, screen data, and an application execution screen.

For example, when an application is executed according to a user's input, the processor 320 may generate a predetermined space, which is called a window, and may configure a screen for the application in the space.

According to an embodiment, the processor 320 may perform, based on a user input (or event) (e.g., a touch input) related to calling an input interface (e.g., a keyboard), an operation of while an application execution screen is displayed through the display 360, calling an input interface and displaying the input interface in at least partial area of the execution screen displayed through the display 360. For example, while a window of a running application is displayed through the entire area of the display 360, the input interface is displayed in a floating state on one area of the window due to a call of the input interface, and thus the one area of the window, which is underlaid by the input interface, may be covered (or may not be shown).

In a case where it is assumed that windows corresponding to multiple applications, respectively, are displayed, when a first window of a first application is displayed through the entire area of the display 360 and a second window of a second application is displayed in a floating state on one area of the first window, the size of the second window may be adjusted, and thus with respect to the first window underlaid by the second window, the one area of the first window, covered due to moving the second window or adjusting the size thereof, may be exposed (or displayed). However, in a case of an input interface (e.g., a keyboard), a key map (or key map area) including numbers, characters, or symbols may be selected (or touched) to allow text input, and thus the input interface may include a key map having a minimum area and/or shape that a user's finger may contact. Therefore, in order to ensure a minimum key map area that is touchable, it may be difficult to adjust the size of the input interface. In addition, in case that the size of a window itself into which text is input through the input interface or the size of a text input area in the window is smaller than a threshold size, there may also be a difficult in user selection (touching) for text input or a selection of an input item. Therefore, according to an embodiment, the processor 320 may adaptively change the input method to allow text to be easily input in various situations.

In an embodiment, while a window of at least one application is displayed, the processor 320 may detect a user selection for displaying an input interface for a window, in which the input interface can be called. For example, the first window of the first application may be displayed through the entire area of the display 360, and the second window of the second application may be displayed in one area of the first window in a floating state. In addition, when a home screen is displayed through the entire area of the display 360, at least one window may be displayed in one area of the home screen in a floating state.

The first application may include at least one of a video application, a game application, or a video call application, and the second application may be an application that provides a text-related function. For example, the text-related function may include message generation, scheduler generation, or document generation, and the type of the text-related function through text input may not be limited thereto.

In an embodiment, the processor 320 may detect a user selection for text input. Here, the user selection may include a user input for calling an input interface, such as a touch input to a text input area. When detecting the user input for calling the input interface, the processor 320 may display a user interface (UI) indicating an input interface (e.g., a keyboard) or display a graphical user interface (GUI) for receiving user speech, based on a pre-configured condition. For example, even if the user input for calling the input interface is detected by the processor 320, if the pre-configured condition is satisfied, the processor 320 may execute a speech recognition function instead of displaying the input interface.

The input interface according to an embodiment may include a keyboard. In addition, the input interface may include an element enabling user control (or user selection), such as an action button and an input item, in addition to the character input through the keyboard.

In an embodiment, the processor 320 may, even when the input interface is called, identify whether a situation in which a predetermined part or more of the full screen is covered by the input interface occurs, as one of pre-configured conditions, and execute a speech recognition function for enabling user input such as text without covering the screen of the running application.

In an embodiment, the pre-configured condition may include a case in which the size of the input interface to be called (or displayed) is greater than a specified size. For example, the specified size may be greater than ⅓ or more or a half of the entire screen of the display, and the specified size may be variously determined. For example, if the size of the input interface to be called (or displayed) is greater than the specified size, the speech recognition function may be executed instead of displaying the input interface.

In addition, as described above whether to execute the speech recognition function may be determined based on the size of the input interface to be called (or displayed), but whether to execute the speech recognition function may also be determined based on a size ratio.

In an embodiment, the processor 320 may identify that a pre-configured condition is satisfied when a ratio of the size of the input interface to the size of a window (or home screen) displayed to occupy the entire screen of the display exceeds a specified ratio. For example, when the window is displayed to occupy most of the display 360, the processor 320 may identify a ratio of the size of the window to the size of the input interface. Alternatively, the processor 320 may identify a ratio of the size of the input interface to the size of the entire screen (e.g., home screen) of the display 360. In case that the size of the input interface is greater than the specified ratio, the processor 320 may execute the speech recognition function instead of displaying the input interface. On the other hand, when the ratio of the size of the input interface to the size of the window (or home screen) does not exceed a specified ratio, the processor 320 may call and display the input interface.

In an embodiment, the pre-configured condition may include a case in which the first application is a specified application. The processor 320 may identify whether the first application corresponding to the first window displayed to occupy the entire screen is a specified application, thereby identifying that a pre-configured condition is satisfied. The processor 320 may execute a speech recognition function, instead of displaying the input interface, based on the first application that is a specified application. Here, the specified application may include at least one of a video application, a game application, or a video call application, but the type of the application may not be limited thereto. For example, when a video-type application involving frequent movement, such as a multimedia, game, or video call application, is running, the speech recognition function may be executed instead of displaying the input interface to prevent the input interface from covering the screen according to the task execution and causing disturbance. By preferentially executing the speech recognition function as described above, a situation in which an application execution screen is covered by a display of the input interface can be prevented.

In an embodiment, the pre-configured condition may include a case in which the size of the window of the application, in which the input interface can be called, is smaller than a specified size. The processor 320 may identify that the pre-configured condition is satisfied when the size of the window is smaller than the specified size. For example, if the size of a window of an application requiring text input is smaller than the specified size, the elements in the window may also be smaller than the minimum area required for user touch. The processor 320 may perform a speech recognition function, instead of displaying the input interface, based on the size of the window that is smaller than the specified size. Meanwhile, if the size of the window is equal to or greater than the specified size, the processor 320 may display the input interface.

In an embodiment, the pre-configured condition may include a case in which in response to a user input for adjusting the size of a window of an application capable of calling an input interface, the adjusted window size reaches a threshold size. The processor 320 may identify, in response to a user input for adjusting the size of the window, whether the size of the window, adjusted according to the user input, has reached the threshold size, and may execute the speech recognition function in response to the size of the window having reached the threshold size. The processor 320 may adjust the size of the window according to a user input, and when the threshold size is reached, may output feedback so that the user may recognize that the speech recognition function is activated. For example, the processor 320 may output an alert message “Speech input is now activated,” or may express a display (or a visual affordance) (e.g., a microphone icon or indicator) indicating that a speech input is available.

In an embodiment, the pre-configured condition may include a case in which a window of at least one application is covered by a virtual object while being displayed in a virtual reality space. The processor 320 may identify that the pre-configured condition is satisfied when a window of an application capable of calling an input interface displayed in the virtual reality space is covered by a virtual object.

In an embodiment, the pre-configured condition may include a case in which a depth of a window of an application displayed in the virtual reality space is identified, the identified depth is greater than a specified depth, and a window size of an application capable of calling the input interface is smaller than the specified size. For example, when the size of a window displayed in the identified depth is smaller than the threshold size, it means that the user is at a distance, and thus this may be a situation in which a field of view is narrowed or another window covers the window. Therefore, when the window of the application that can call the input interface is displayed small due to a depth of the window, the processor 320 may execute a speech recognition function instead of displaying the input interface.

As described above, the pre-configured condition for executing the speech recognition function instead of displaying the input interface may be various, such as a ratio of the input interface or the size of the window to the full screen, as well as the size of the input interface or the size of the window in which the input interface can be called. For example, in a case of a widget (or a pop-up screen, a split screen, or a pre-configured screen) in which text input is possible, when a user selection for the widget is detected, the processor 320 may execute a speech recognition function instead of displaying the input interface. Therefore, the example of a pre-configured condition for executing a speech recognition function instead of displaying the input interface in response to a user input for calling the input interface is not limited thereto.

Meanwhile, in order to execute the speech recognition function, the processor 320 may control the microphone to be in an on state. If the state of receiving a speech input is available, the processor 320 may output a graphic visual effect (e.g., a microphone icon or an indicator) indicating that a speech input is possible. For example, the processor 320 may output a visual effect by using the border of an input area or an icon, or may output various sounds such as music or a notification sound that can be output through a speaker, or a notification in various vibration forms such as a haptic, and the method of outputting the notification may not be limited thereto.

In addition, when a speech input is received through the microphone, the processor 320 may represent that the speech input by using a graphic object (e.g., an icon) indicating that the speech input is in progress. The processor 320 may display the user's speech converted into text in a specific area. For example, when the user inputs a message in a chat application, the processor 320 may display the user input converted to text in a chat input area. As described above, by adaptively changing the input method for inputting text according to various situations, the user can more easily use functions of the electronic device, whereby user convenience and satisfaction can be increased.

According to an embodiment, the electronic device 101 may include a display 160 or 360, at least one processor 120 or 320 operationally connected to the display, and memory 130 or 330 for storing instructions. According to an embodiment, the instructions, when executed by the at least one processor, may be configured to cause the electronic device to display a window of an application. According to an embodiment, the instructions may be configured to cause the electronic device to detect a user selection for displaying an input interface for the window. According to an embodiment, the instructions may be configured to cause the electronic device to compare a size of the window or the input interface with a specified size, in response to the user selection. According to an embodiment, the instructions may be configured to cause the electronic device to execute one of the display of the input interface or the speech recognition function, based on a result of the comparison.

According to an embodiment, the instructions may be configured to cause the electronic device to execute the speech recognition function in case that the size of the input interface is greater than the specified size.

According to an embodiment, the instructions may be configured to cause the electronic device to execute the speech recognition function in case that the size of the input interface is greater than the specified size while a window of a specified application different from the application is displayed.

According to an embodiment, the specified application may include at least one of a video application, a game application, or a video call application.

According to an embodiment, the instructions may be configured to cause the electronic device to execute the speech recognition function in case that the size of the window is smaller than the specified size.

According to an embodiment, the instructions may be configured to cause the electronic device to identify, in response to a user input for adjusting the size of the window, whether the size of the window, adjusted according to the user input reaches a threshold size, and output feedback regarding execution of the speech recognition function in response to the size of the second window having reached the threshold size.

According to an embodiment, the instructions may be configured to cause the electronic device to display, in the window, text corresponding to the input speech by using the speech recognition function.

According to an embodiment, the instructions may be configured to cause the electronic device to display a window of the application in a virtual reality space.

According to an embodiment, the instructions may be configured to cause the electronic device to execute the speech recognition function when the window of the application displayed in the virtual reality space is covered by a virtual object.

According to an embodiment, the instructions may be configured to cause the electronic device to identify a depth of the window of the application displayed in the virtual reality space, and execute the speech recognition function when the identified depth is greater than a specified depth and the size of the window is smaller than the specified size.

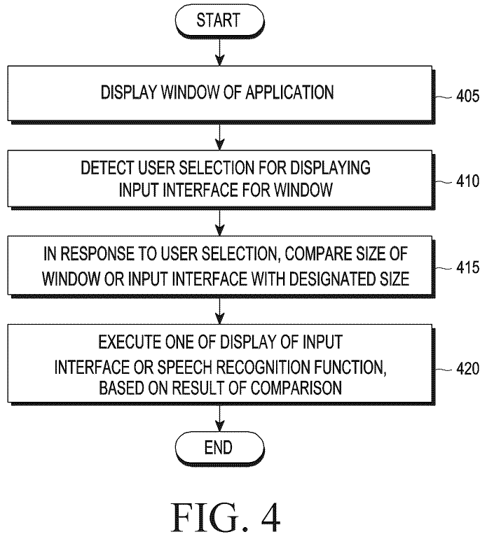

FIG. 4 is a flowchart illustrating operations of an electronic device for executing a speech recognition function according to an embodiment of the disclosure.

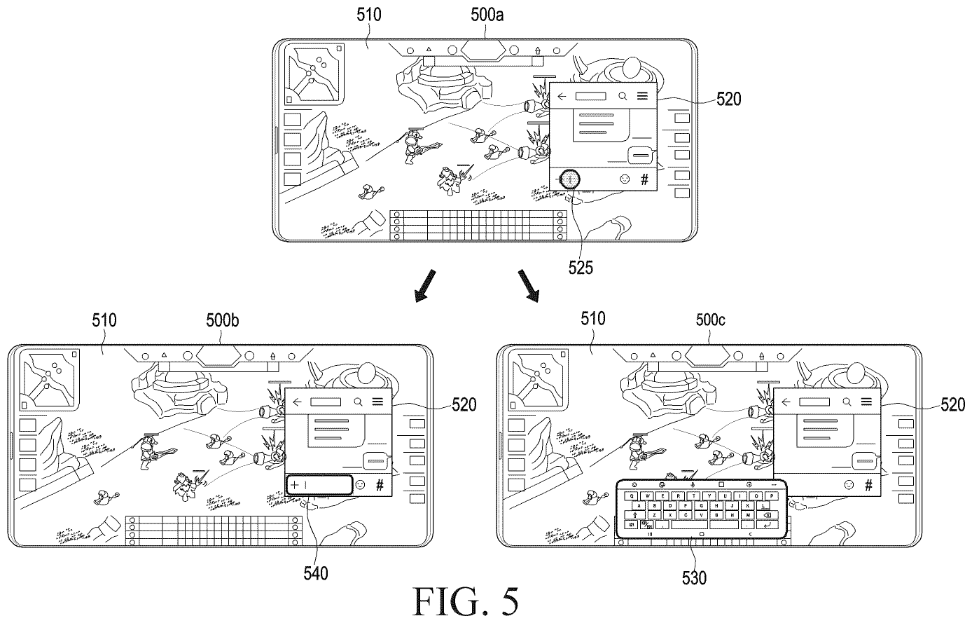

Referring to FIG. 4, the method may include operations 405 to 420. Each of the operations of the method of FIG. 4 may be performed by an electronic device (e.g., at least one of the electronic device 101 of FIGS. 1 to 3 or at least one processor (e.g., the processor 120 of FIG. 1 or the processor 320 of FIG. 3) of the electronic device). In an embodiment, at least one of operations 405 to 420 may be omitted, the order of some of the operations may be changed, or another operation may be added. The description of FIG. 4 will be made with reference to FIGS. 5 to 7 to facilitate the understanding of the description of FIG. 4.

In operation 405, the electronic device 101 may display a window of an application. The application may be an application capable of calling an input interface. The window of the application may be displayed in one area of the entire display area. In addition, in case that a home screen is displayed through the entire display area, the application capable of calling the input interface may be displayed in one area of the home screen.

In an embodiment, it may be assumed that a first window of a first application is displayed through the entire area of the display, and a second window of a second application is displayed in one area of the first window. According to an embodiment, the first window of the first application may include an execution screen of at least one of a video application, a game application, or a video call application, and the type of the application is not limited thereto. In addition, the second application may be an application for providing a text-related function. The second window of the second application may be an execution screen of an application including, for example, message generation, scheduler generation, or document generation. For example, the first window of the first application may be displayed to occupy most or at least a part of the display 360, and the second window of the second application may be displayed to at least partially overlap the first window.

In operation 410, the electronic device 101 may detect a user selection for displaying an input interface for the window. According to an embodiment, the electronic device 101 may identify a user selection for text input such as message generation, scheduler generation, or document generation.

FIG. 5 illustrates a screen when an input interface is called according to an embodiment of the disclosure.

When a user wants to generate a message in a chat application 520 while a game application 510 is being executed, as illustrated in 500a of FIG. 5, a user selection for text input may be a user input (e.g., a touch input) 525 for a specific area of the chat application. Here, the user selection for text input may be considered as input for calling an input interface (e.g., a keyboard or a soft input panel (SIP)).

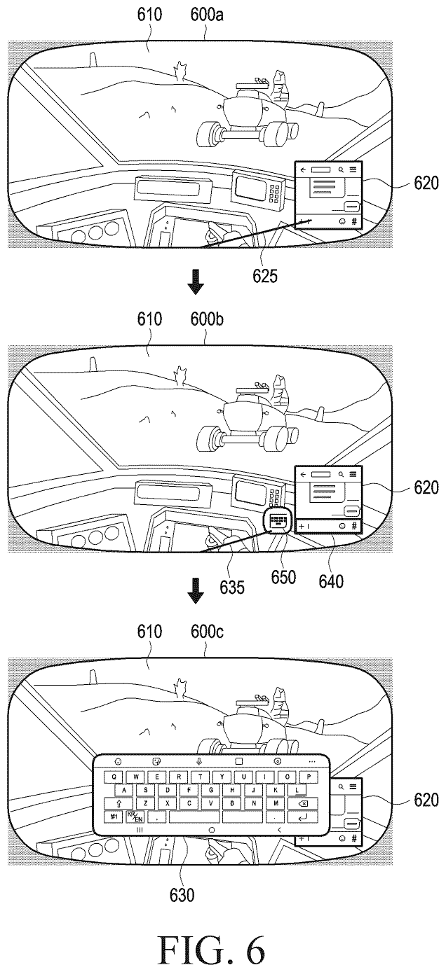

FIG. 6 illustrates a screen when an input interface is called in a virtual reality space according to an embodiment of the disclosure.

When the user wants to generate a message through a chat application 620 while a game application 610 is being executed, as illustrated in 600a of FIG. 6, the user may select 625a text input area of the chat application 620. In case that the game application 610 is being executed in the virtual reality space, selection of the text input area may be a pointer input (or input by using a controller).

In operation 415, the electronic device 101 may compare a size of the window or the input interface with a specified size in response to the user selection. For example, the electronic device 101 may identify the size of the window or the input interface as a pre-configured condition in order to identify whether the input interface can be displayed before calling the input interface.

In operation 420, the electronic device 101 may execute, based on the result of the comparison, one of a display of the input interface or a speech recognition function.

According to an embodiment, the electronic device 101 may execute the speech recognition function when the size of the input interface is greater than the specified size. On the other hand, in case that the size of the input interface is smaller than the specified size, the electronic device 101 may display the input interface. For example, when the size of the input interface is greater than a specified size and most of the screen that is being executed is thus covered by the input interface, the electronic device 101 may execute a speech recognition function instead of displaying the input interface. For example, the designated size may be greater than ⅓ or more or a half of the entire screen of the display, but this is only an example, and the specified size (or numerical value) may be differently configured.

According to an embodiment, the electronic device 101 may execute the speech recognition function when the size of the window is smaller than the specified size. According to an embodiment, the electronic device 101 may display, in the window, text corresponding to the input speech by using the speech recognition function. On the other hand, the electronic device 101 may display the input interface when the size of the window is greater than the specified size. For example, in case that the size of a window itself for providing a text-related function is smaller than a specified size, making it difficult to input text, the electronic device 101 may perform the speech recognition function instead of displaying the input interface. For example, when the size of a touchable item within the window is smaller than a minimum touch area, or the size of a text input area within the window is smaller than the minimum touch area, it may be inconvenient to input text. Therefore, the electronic device 101 may compare the size of the window providing the text-related function with the specified size to determine whether to execute the speech recognition function. For example, the specified size compared to the size of the window itself may be determined based on the minimum touch area, but this is only an example, and the specified size (or numerical value) may be differently configured.

Although the electronic device 101 may determine whether to execute the speech recognition function, based on the size of the input interface to be called (or displayed), the electronic device 101 may also determine, based on a size ratio, whether to execute the speech recognition function.

In an embodiment, the electronic device 101 may compare the size ratio of the input interface with a specified ratio with reference to the entire screen of the display. In a state in which a window occupying the entire display screen is displayed, the electronic device 101 may compare the size ratio of the input interface with a specified ratio with reference to the window. The electronic device 101 may perform the speech recognition function when the size ratio of the input interface is greater than the specified ratio, and may display the input interface when the size ratio of the input interface is smaller than the specified ratio.

In addition, in an embodiment, the electronic device 101 may compare the size ratio of the window for providing the text-related function with a specified ratio with reference to the entire screen of the display. In a case where a window of a specified application, which is different from the window, is displayed to occupy the entire screen of the display, the electronic device 101 may compare the size ratio of the window with a specified ratio with reference to the entire screen or the window displayed to occupy the entire screen. The electronic device 101 may execute the speech recognition function when the size ratio of the window is smaller than the specified ratio. For example, if a window is displayed in a size smaller than a specified ratio compared to the entire screen, a touch input may be limited, and thus the speech recognition function may be executed. On the other hand, if the window size ratio is greater than the specified ratio, the window is displayed in a size greater than the specified ratio compared to the entire screen size, so that an input interface which can be called in the window may be displayed.

For example, as illustrated in 500b of FIG. 5, during execution of a game application 510 in a mobile environment, in response to a user input (e.g., a touch input) 525 for a specific area of a chat application 520, if the size of an input interface to be displayed compared to the size of the game application 510 is greater than a specified size, the input interface may not be displayed, and the speech recognition function may be executed instead of displaying the input interface. In addition, when the ratio of the size of the input interface to be displayed is greater than the specified ratio with referend to the size of the game application 510 displayed to occupy the entire screen of the display, the electronic device 101 may also execute the speech recognition function instead of displaying the input interface.

On the other hand, as illustrated in 500c of FIG. 5, when the size of the input interface 530 to be displayed is smaller than the specified size, the input interface 530 may be displayed. In addition, in case that the size ratio of the input interface 530 is smaller than a size ratio based on the execution screen of the game application 510 or the entire screen of the display 360, the input interface 530 may be displayed in at least a part of the execution screen of the game application 510.

In addition, as illustrated in 600b of FIG. 6, during execution of the game application 510 in a virtual reality environment, if the size of the chat application 620 is smaller than a threshold size, a speech recognition function may be executed instead of displaying the input interface. In consideration of a case where a user wants to display an input interface rather than executing a speech recognition function, an icon 650 for displaying the input interface may be displayed. In response to a user selection 635 for the icon 650, the electronic device 101 may display the input interface 630 through an independent area (or window) that is distinguished from the execution screens of the game application 510 and the chat application 620, as illustrated in 600c of FIG. 6. In addition, in case that the user selects the text input area again, the electronic device 101 may display the input interface 630. The method for activating the display of the input interface is not limited thereto.

A case in which the speech recognition function is executed when the size of the chat application 620 is smaller than a threshold size is described as an example above, but the electronic device 101 may display the input interface 630 when a surrounding space is wide even though the size of the chat application 620 is smaller than the threshold size. In addition, an audio playback application, which is not an application requiring screen output such as a game application, may operate in the background, and thus the electronic device 101 may display the input interface 630. Therefore, a condition for determining to either display the input interface or execute the speech recognition may vary.

As illustrated in 500b of FIGS. 5 and 600b of FIG. 6, when the speech recognition function is executed, the electronic device 101 may display an indication (e.g., a microphone icon or an indicator) 540 or 640 indicating that speech input is possible. For example, the electronic device 101 may output a visual effect by using the border of the input area or an icon, and may output a notification in various manners such as sound or haptic feedback, and the method of outputting the notification may not be limited thereto.

According to an embodiment, in response to a user input for adjusting the size of the window of the application capable of calling the input interface, the electronic device 101 may identify whether the size of the window, adjusted according to the user input, reaches a threshold size. In response to the size of the window reaching the threshold size, the electronic device 101 may output feedback for executing the speech recognition function. When the size of the window is adjusted according to the user input and reaches a threshold size, the electronic device 101 may output feedback so that the user can recognize that the speech recognition function is activated.

According to an embodiment, in a state where a window of a specified application, which is different from the application capable of calling the input interface, is displayed, when the size of the input interface is greater than the specified size, the electronic device 101 may execute the speech recognition function. The specified application may include at least one of a video application, a game application, or a video call application.

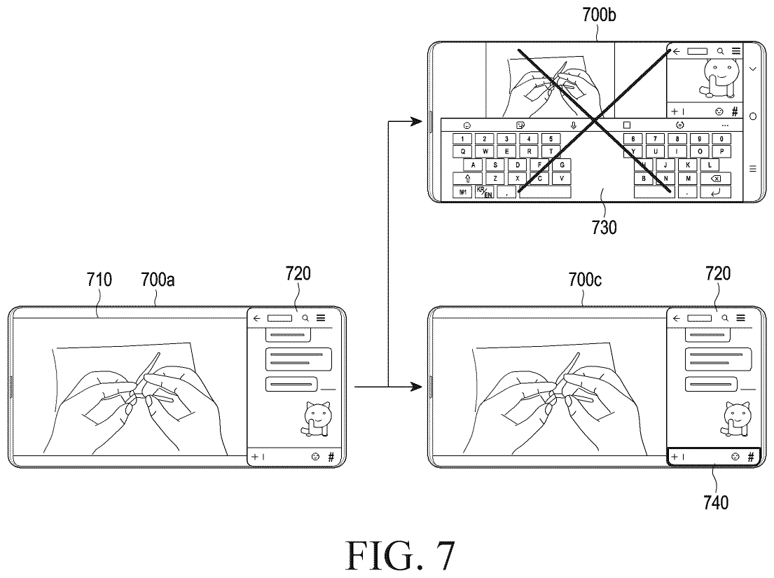

FIG. 7 is a view illustrating an example of a screen on which a speech recognition function is executed instead of displaying an input interface when a specified application is being executed according to an embodiment of the disclosure.

As illustrated in 700a of FIG. 7, while a video application 710 and a chat application 720 are displayed, the electronic device 101 may receive a user selection of a specific input area of the chat application 720. In response to the user selection, when the electronic device 101 calls and displays an input interface (e.g., a keyboard) 730, most of the execution screen may be covered, as illustrated in 700b. In an embodiment, as illustrated in 700c, the electronic device 101 may identify whether the application being executed is a specified application, and when the application being executed is the specified application, the electronic device 101 may display a display 740 indicating that the speech input is possible by executing the speech recognition function. Accordingly, when an attempt is made to input text, the speech recognition function may be prioritized to be provided according to the type of the application being executed so that the viewing is not disturbed.

According to an embodiment, the electronic device 101 may display a window of the application in a virtual reality space.

According to an embodiment, when the window of the application displayed in the virtual reality space is covered by a virtual object, the electronic device 101 may execute the speech recognition function.

According to an embodiment, the electronic device 101 may identify a depth of a second window of a second application displayed in the virtual reality space.

According to an embodiment, when the identified depth is greater than a specified depth and the size of the window smaller than a specified size, the electronic device 101 may execute the speech recognition function.

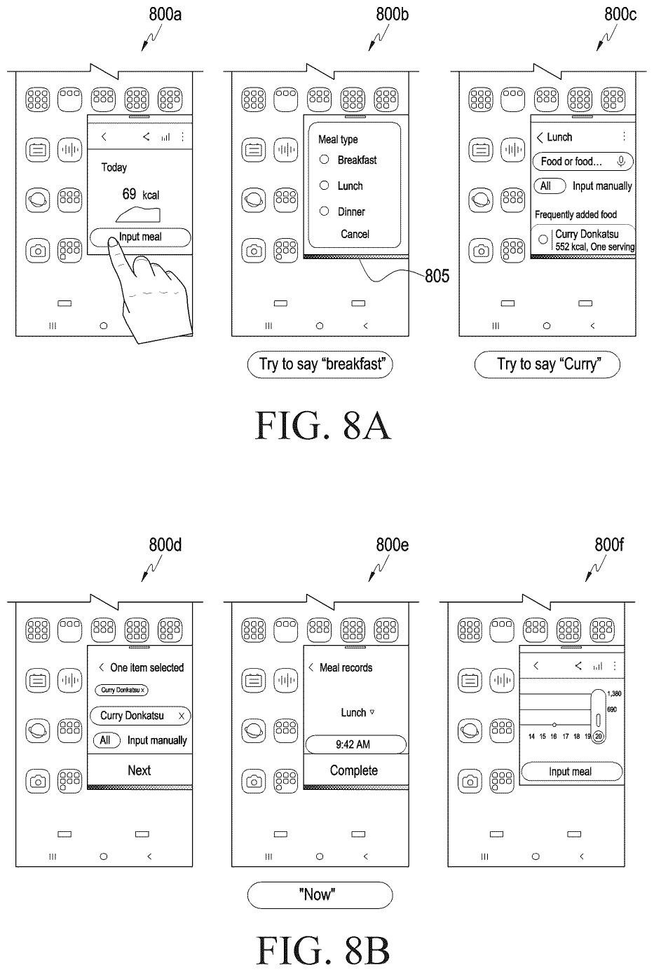

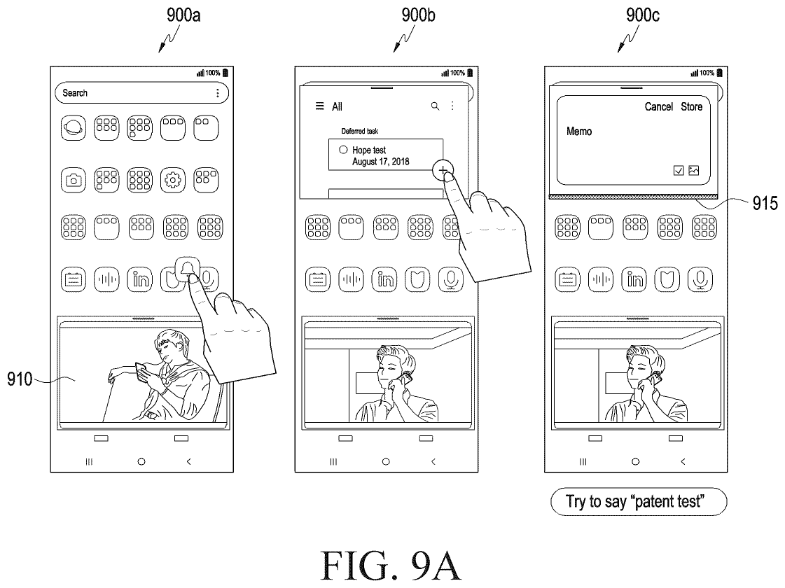

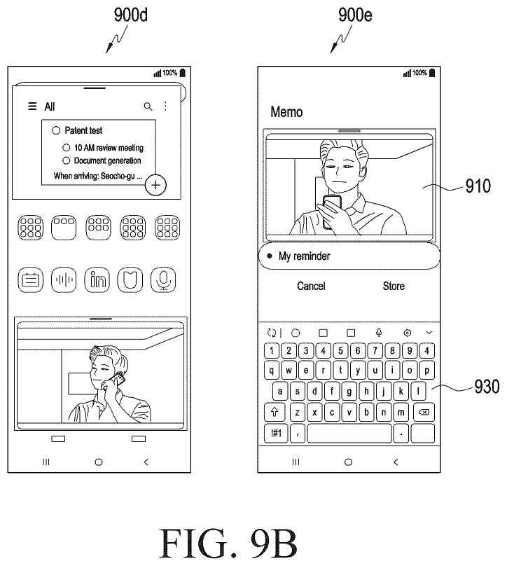

Meanwhile, in the description above, a case in which the speech recognition function is executed in response to a user selection through a text input area has been described as an example, but in FIGS. 8A, 8B, 9A, and 9B below, a case in which the speech recognition function is executed in response to a user selection for a component to which input is required will be described.

FIG. 8A illustrates a screen on which an input item is input using a speech recognition function according to an embodiment of the disclosure, and FIG. 8B illustrates a screen following FIG. 8A according to an embodiment of the disclosure.

Referring to 800a in FIG. 8A, the electronic device 101 may display a widget in a pop-up form on at least a part of the entire screen. Although a widget is exemplified in FIG. 8A, the speech recognition function may be executed instead of displaying the input interface through a pop-up screen, a split screen, or a pre-configured screen.

A widget is a mini application (application program or software) which is one of the graphical user interfaces (GUIs) that more smoothly support interaction between a user and an application program and an operating system. That is, the widget is a mini application that enables the user to use various information services without using a web browser in the electronic device 101. The widget may perform a shortcut function on a standby screen of the electronic device.

According to an embodiment, in response to a user selection (e.g., a touch input) for a specific component of a widget, the electronic device 101 may input contents for the selected component through a speech recognition function. In an embodiment, as illustrated in 800b, when the size of the widget itself is smaller than or equal to a specified ratio (e.g., n%) with respect to the entire screen, the contents of the item within the widget may be input by speech. For example, as illustrated in 800b, the electronic device 101 may output a visual effect 805 by using the border of the widget or an icon to indicate a state in which a speech input can be received.

When the electronic device 101 recognizes a speech input and the recognized speech input does not correspond to a language supported by the widget, the electronic device 101 may process the speech input as an error state, and when the recognized speech input corresponds to a supported language, the electronic device may sequentially display, as in 800c to 800e, contents that are input by speech, for the corresponding item in response to the recognized speech. For example, when the speech recognition result input through the utterance and text of the corresponding item in the widget match, the contents reflecting the speech recognition result may be displayed for the corresponding item. When no additional user speech is received within a predetermined time, the display indicating the case in which the speech input can be received may be removed, as in 800f of FIG. 8B, after the microphone is turned off.

FIG. 9A illustrates a screen on which a speech recognition function is executed during text input through a widget when a specified application is being executed according to an embodiment of the disclosure, and FIG. 9B illustrates a screen following FIG. 9A according to an embodiment of the disclosure.

Referring to 900a of FIG. 9A, a frequently used application or contents may be displayed by using a pop-up object while a video application 910 is being executed. When the user selects the pop-up object, the electronic device 101 may display a widget corresponding to the pop-up object in response to the user selection, as illustrated in 900b. In response to a user selection (e.g., a touch input) of a specific component of the widget, it may be identified whether a pre-configured condition is satisfied before calling the input interface. For example, the electronic device 101 may identify whether a ratio of the size of the widget to the entire screen exceeds a threshold ratio. Alternatively, the electronic device 101 may identify whether an application being executed is a specified application. When the specified application is running, the speech recognition function may be executed instead of the display of the input interface. In addition, when the ratio of the size of the widget to the entire screen is greater than a threshold ratio, the electronic device 101 may perform the speech recognition function as illustrated in 900c. When the ratio of the size of the widget to the entire screen does not exceed the threshold ratio, the input interface 930 may be displayed as illustrated in 900e of FIG. 9B.

On the other hand, when the speech recognition function is executed, the electronic device 101 may display an input field in which text input can be made, as illustrated in 900c. The electronic device 101 may output (or display) a visual effect (or display or graphic object) 915 indicating a state in which a speech input is possible. For example, when a speech input such as “patent test” is made, the contents of the corresponding component may be input through the speech recognition function, as illustrated in 900d of FIG. 9B, and the electronic device 101 may remove a display indicating a state in which a speech input can be received when the storage is completed.

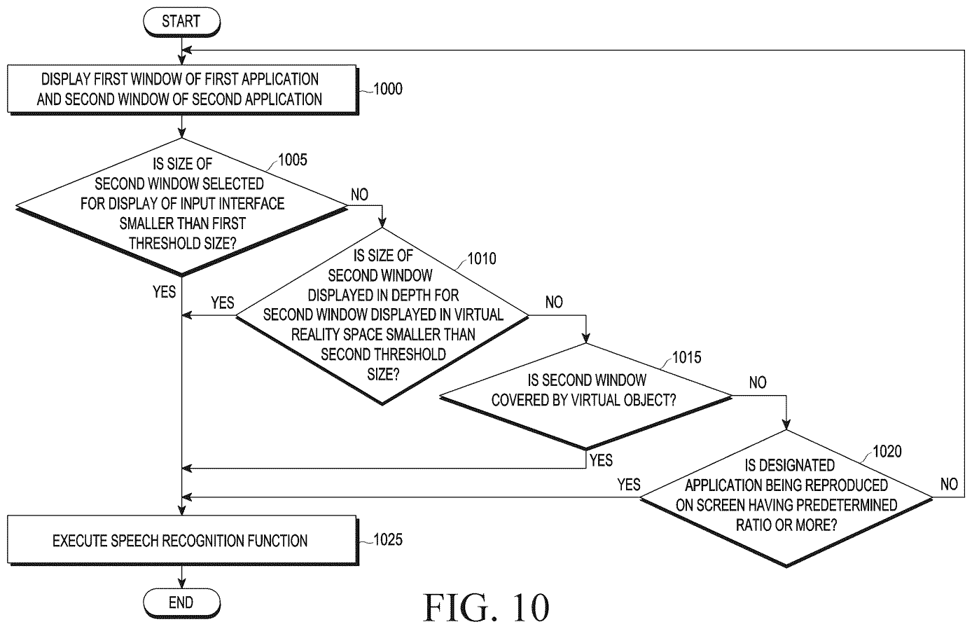

FIG. 10 is a flowchart illustrating operations for determining whether to execute a speech recognition function according to an embodiment of the disclosure.

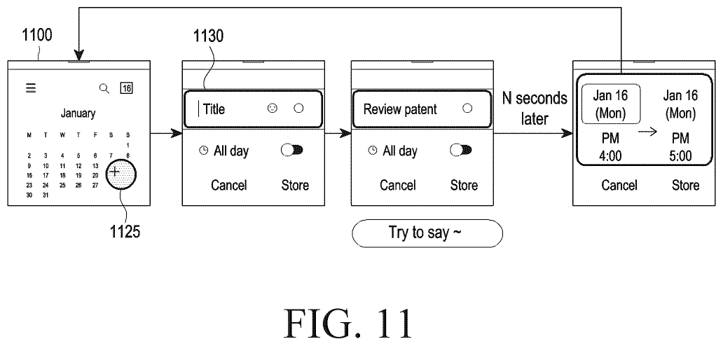

Referring to FIG. 10, the operation method may include operations 1000 to 1025. Each of the operations of the method of FIG. 10 may be performed by an electronic device (e.g., at least one of the electronic device 101 of FIGS. 1 and 3 or at least one processor (e.g., the processor 120 of FIG. 1 or the processor 320 of FIG. 3) of the electronic device). In an embodiment, at least one of operations 1000 to 1025 may be omitted, the order of some of the operations may be changed, or another operation may be added. The description of FIG. 10 will be made with reference to FIGS. 11, 12A, 12B, 13, 14A, 14B, 15, 16, 17A to 17C, 18A, and 18B to facilitate the understanding of the description of FIG. 10.

In operation 1000, the electronic device 101 may display a first window of a first application and a second window of a second application. According to an embodiment, the first window of the first application and the second window of the second application may be displayed in a mobile environment or a virtual reality space. For example, the first window of the first application may be displayed to occupy the entire screen of the display, and the second window of the second application may be displayed in a floating form on a part of the first window or a part of the entire screen.

In operation 1005, the electronic device 101 may identify whether the size of the second window selected for display of the input interface is smaller than a first threshold size.

The input interface according to an embodiment may include a keyboard. In addition, the input interface may include elements that allow user operations (or user selections), such as action buttons and input items, other than character input via the keyboard.

In case that the size of the second window is not smaller than the first threshold size, operation 1010 may be performed. On the other hand, in case that the size of the second window is smaller than the first threshold size, the electronic device 101 may execute a speech recognition function in operation 1025. For example, in case that the size of the second window (or widget) selected by the user is smaller than or equal to the first threshold size, or a ratio of the size of the second window (or widget) to the entire screen is smaller than or equal to a specified ratio, there is a risk of misinput when the input is made through a touch, and thus the electronic device 101 may prioritize the execution of the speech recognition function.

In operation 1010, the electronic device 101 may identify whether the size of the second window displayed in the depth of the second window displayed in the virtual reality space is smaller than a second threshold size. If the size of the second window displayed in the depth of the second window is not smaller than the second threshold size, operation 1015 may be performed. On the other hand, in case that the size of the second window displayed in the depth for the second window is smaller than the second threshold size, the electronic device 101 may execute the speech recognition function in operation 1025. For example, when the depth of the second window is greater than a specified depth and a display ratio of the second window is equal to or smaller than a threshold ratio with reference to a field of view, it may indicate a state in which the second window is too far to be selected by the user, and thus the speech recognition function may be prioritized to be executed in order to prevent a user's misinput.

In operation 1015, the electronic device 101 may identify whether the second window is covered by a virtual object. If the second window is not covered by the virtual object, operation 1020 may be performed. On the other hand, in case that the second window is covered by the virtual object, the electronic device 101 may perform the speech recognition function in operation 1025. For example, even in a case in which the second window needs to be selected for text input, but the selection is difficult due to an interference of another object, the speech recognition function may be prioritized to be executed.

In operation 1020, the electronic device 101 may identify whether a specified application is being played on a screen of a specified ratio or more. In case that a specified application is not being played on the screen of the specified ratio or more, the return to operation 1000 and the above-described operations may be performed. On the other hand, when the specified application is being played on the screen of the specified ratio or more, the electronic device 101 may execute the speech recognition function in operation 1025.

As described above, the electronic device 101 may identify whether various conditions are satisfied to activate the speech recognition function instead of displaying the input interface. For example, even when the electronic device 101 is reproducing content through a screen area of a half or more of a background screen or the entire screen, the electronic device 101 may prioritize execution of the speech recognition function. In addition, in case that a user's selection of the second window (or widget) corresponds to a control scheme without a physical contact, such as a user gesture, the electronic device 101 may prioritize the execution of the speech recognition function. The various conditions for activating the speech recognition function instead of the display of the input interface may not be limited to the above-described conditions.

FIG. 11 illustrates a screen indicating an input interface using a speech recognition function according to an embodiment of the disclosure.

Referring to 1100 of FIG. 11, an application (e.g., a calendar application) providing a text-related function may provide a scheduler generation function using a speech recognition function. For example, in response to a user selection 1125 of a component requiring input in the window (or widget) of the application, the electronic device 101 may identify whether the size of the window is equal to or smaller than a threshold size. Based on the window size being smaller than or equal to the threshold size, the electronic device 101 may indicate, as in 1130, that the speech input is possible. For example, the electronic device 101 may activate and display a first input item (e.g., a title). If a speech input is received from the user, the electronic device 101 may display, in the first input item, text corresponding to a speech recognition result. Thereafter, after a predetermined time has elapsed, the next input item (e.g., month/day or time) may be activated and displayed. The electronic device 101 may perform an operation of, after auto-focusing of sequentially selecting input items, receiving a user's speech through the microphone. As long as an operation execution command such as storage or cancellation is not received, the operation of receiving a user's speech through the microphone may be performed while the focusing of a current position is maintained.

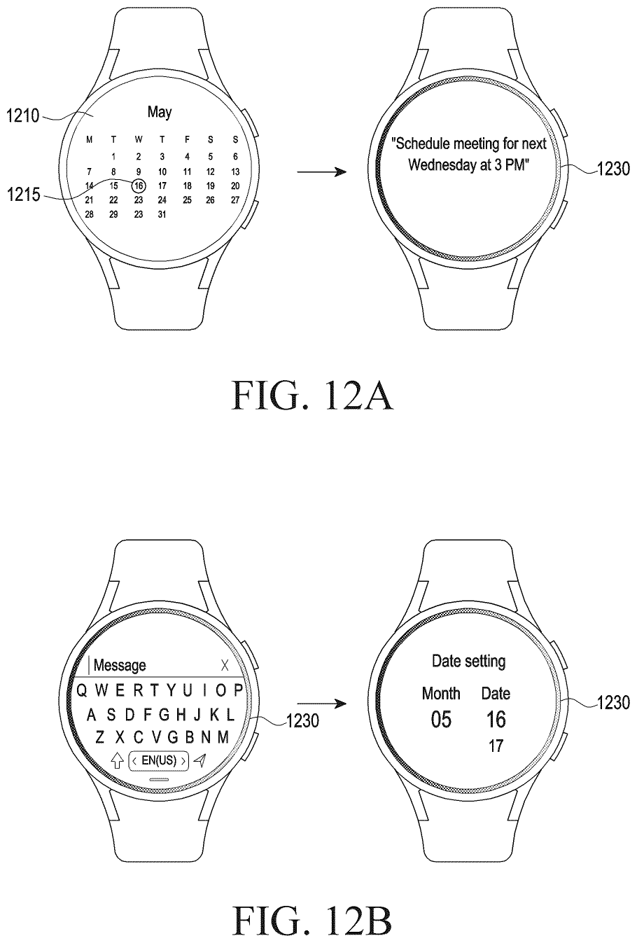

FIG. 12A illustrates a screen indicating an input interface associated with a schedule function using a speech recognition function in a wearable electronic device according to an embodiment of the disclosure, and FIG. 12B illustrates a screen indicating an input interface associated with a message function using a speech recognition function in a wearable electronic device according to an embodiment of the disclosure.

Referring to FIG. 12A, the size of a display itself of a wearable electronic device may be very limited. Therefore, for an application (e.g., a calendar application) 1210 that provides a text-related function, the execution of a speech recognition function may be prioritized in response to a user selection 1215 for text input in order to provide a schedule generation function. While the speech recognition function is being executed, the wearable electronic device may output a graphic visual effect 1230 that indicates a speech input state.

Referring to FIG. 12B, the wearable electronic device may execute the display of the keyboard and the speech recognition function so that touching and speech input can be simultaneously performed, based on the size of a touchable key map area.

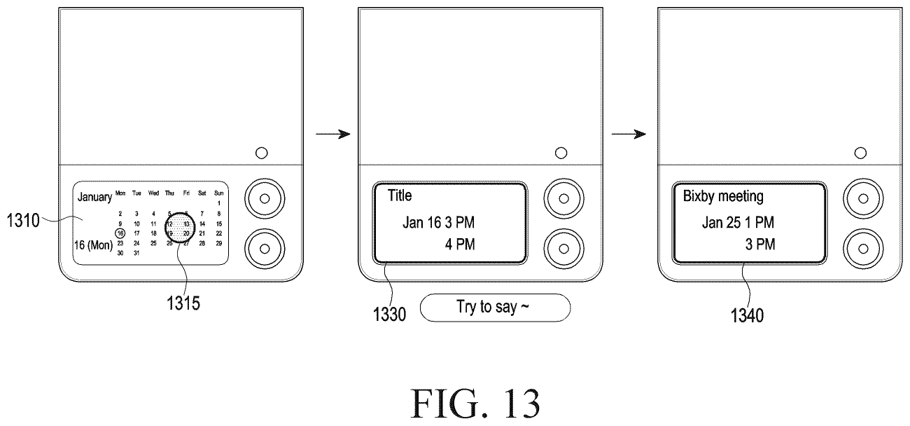

FIG. 13 illustrates a screen on which a speech recognition function is executed based on a size of a display according to an embodiment of the disclosure.

Referring to FIG. 13, a graphic user interface including an area and/or an element in which time information and/or content can be displayed may be displayed on a sub display which is visually exposed when the electronic device 101 is in a folded state. In response to a specified user input (e.g., a long press), an execution screen of an application (e.g., a calendar application) 1310 that provides a text-related function may be displayed through the sub display. In response to a user selection 1315 of the input item in the execution screen, the electronic device 101 may prioritize the execution of the speech recognition function in order to provide the scheduler generation function. During the execution of the speech recognition function, the electronic device 101 may output a graphic visual effect 1330 indicating a speech input state. In case that a speech input is received through the microphone, the electronic device 101 may display (1340) the user's speech converted into text through speech recognition in a specific area.

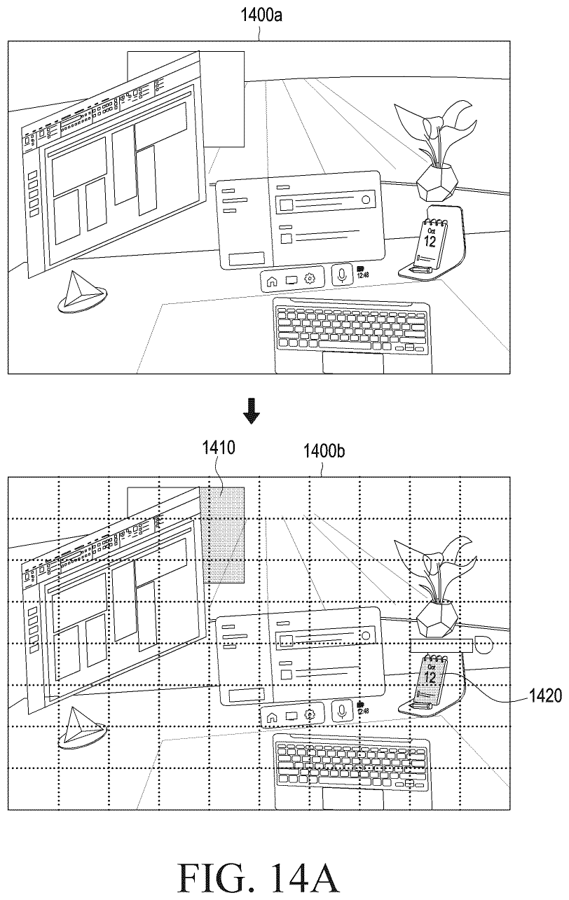

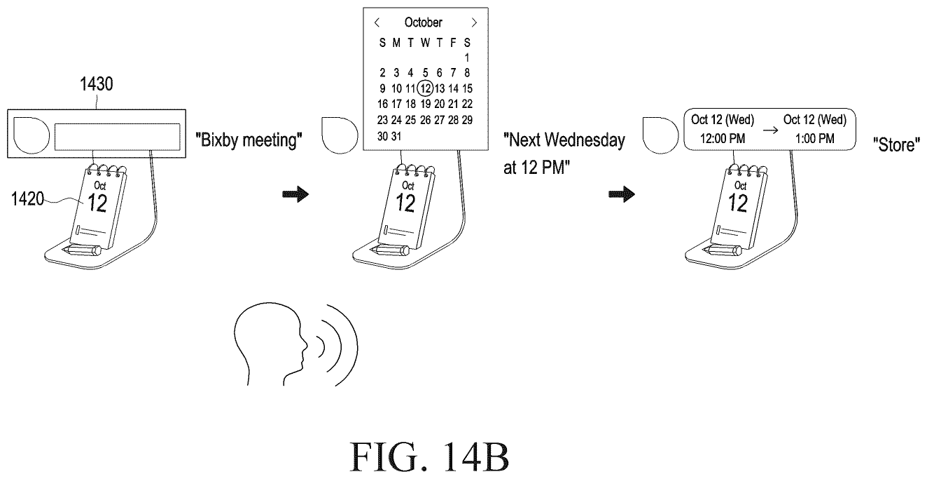

FIG. 14A illustrates a screen on which a speech recognition function is executed when a size of an input target for which user input for an input item and text is possible in a virtual reality space is equal to or smaller than a threshold size according to an embodiment of the disclosure, and FIG. 14B illustrates a method of inputting an input item using a speech recognition function according to an embodiment of the disclosure.

Referring to 1400a of FIG. 14A, a case in which a calendar in the form of a widget is displayed in a virtual reality space is exemplified. For example, in a state in which other windows are overlapped by the window of an application as in 1400b, only a part 1410 of the overlapped window may be visually exposed, and in the case of the calendar 1420 in the form of a widget, the size of a selectable area may be smaller than the threshold size.

According to an embodiment, with reference to an area visible to the user in a field of view (FOV), the part 1410 of the overlapped window and the calendar 1420 in the form of a widget may each be equal to or smaller than a threshold size. If the user selects the calendar 1420 to generate a schedule, the electronic device 101 may execute a speech recognition function to generate a schedule for the calendar 1420 as illustrated in FIG. 14B, instead of displaying a keyboard. When the calendar 1420 having a size smaller than the threshold size is selected, the electronic device 101 may execute the speech recognition function and control to enable input through speech recognition within a specified input area 1430.

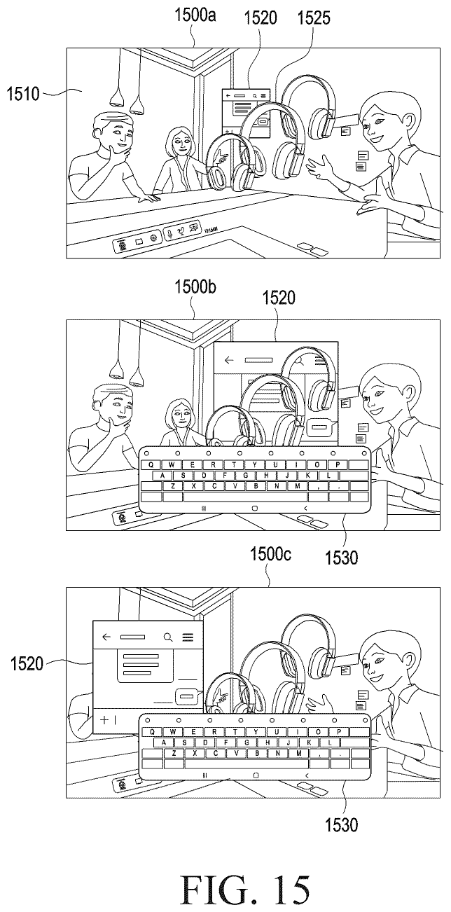

FIG. 15 illustrates a screen on which a speech recognition function is executed when an input target for which user input for an input item and text is possible is covered by a virtual object according to an embodiment of the disclosure.

Referring to 1500a of FIG. 15, a state in which a first window of a first application 1510 and a second window of a second application 1520 are displayed in a virtual reality space is illustrated. In a case where the second application 1520 is an application providing a text-related function, when the user selects the second window of the second application 1520, the second window may be activated but the disposition position of the second window may not be changed. Therefore, even when only a part of the second window is seen, the electronic device 101 may turn on the microphone and execute a speech recognition function so that text input is possible. Accordingly, according to an embodiment, even when a second window of the second application 1520 is at least partially covered by a virtual object 1525, text input through the speech recognition function may be possible.

According to an embodiment, as illustrated in 1500b, in a case where the second window of the second application 1520 is enlarged while maintaining the distance, or in a case where the position thereof is moved, as illustrated in 1500c, a part covered by the virtual object 1525 may be exposed, and a part occupied by the second window of the second application 1520 compared to the entire screen may become wider. If the size or size ratio of the second window of the second application 1520 is equal to or greater than a specified size or equal to or greater than a specified ratio compared the entire screen, the electronic device 101 may suspend the speech recognition function, and display a virtual keyboard 1530 to allow the user to input text through the virtual keyboard 1530.

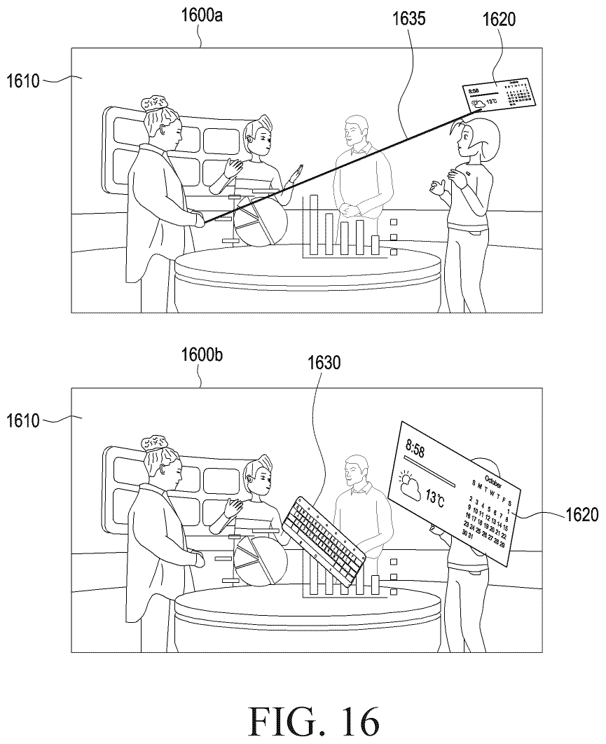

FIG. 16 illustrates a screen on which a speech recognition function is executed using a user gesture according to an embodiment of the disclosure.

Referring to 1600a of FIG. 16, based on a user selection 1635 of a calendar application 1620 that provides a text-related function in a state in which a specific application 1610 is being executed, the electronic device 101 may execute the speech recognition function. For example, the electronic device 101 may identify whether the user selection 1635 of the calendar application 1620 is a specified user gesture. If the specified user gesture is identified, the electronic device 101 may execute the speech recognition function to operate in a state in which a user's speech can be received. As such, the specified user gesture may indicate a user input to directly execute the speech recognition function instead of displaying the input interface.

Unlike in 1600a, based on an input for enlarging the size of the calendar application 1620 or changing the position of the calendar application 1620, as in 1600b, the electronic device 101 may display a virtual keyboard 1630. When the ratio of the calendar application 1620 to the entire screen increases to a level equal to or greater than a threshold ratio in response to an input for increasing the size of the calendar application 1620 or changing the position of the calendar application 1620, the electronic device 101 may activate the display of the input interface 1630.

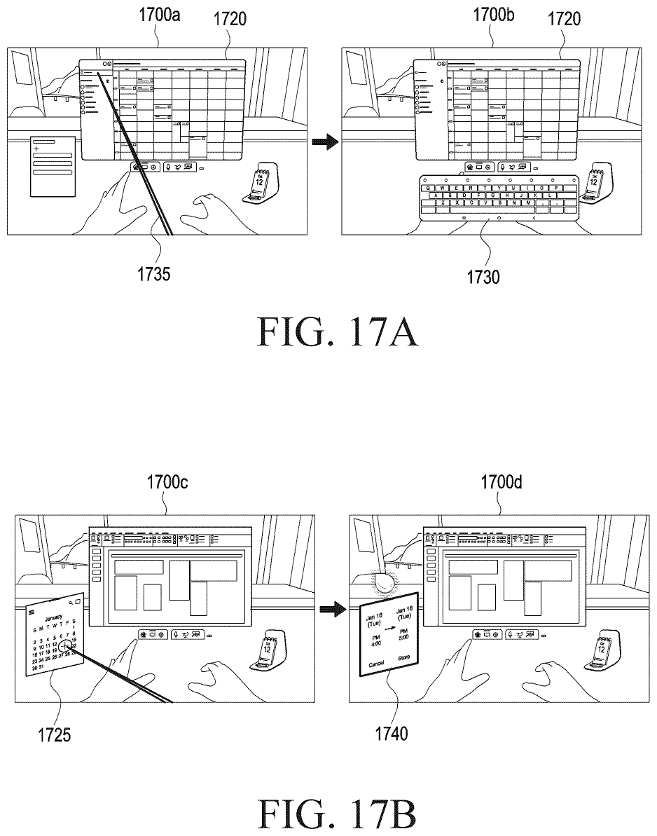

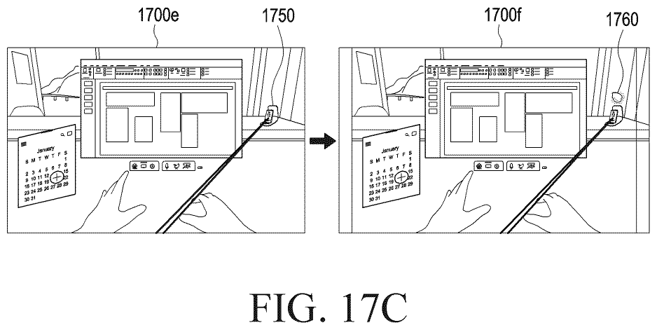

FIG. 17A illustrates a screen on which a keyboard for text input is displayed according to an embodiment of the disclosure.

Referring to 1700a of FIG. 17A, the electronic device 101 may detect a user input 1735 for selecting a window of a calendar application 1720 in a state in which the window of the calendar application 1720 is displayed without being covered by other windows, e.g., at the topmost in the layer structure in a virtual reality space. In response to the user input 1735, the electronic device 101 may display an input interface 1730 as illustrated in 1700b.

FIG. 17B illustrates a screen on which a speech recognition function is executed when an input target for which user input for an input item and text is possible is selected according to an embodiment of the disclosure. Here, the input target may refer to an element enabling user control (or user selection) such as such as an action button and an input item, in addition to input of characters through a keyboard, and may include all elements configurable through speech input.

Referring to 1700c of FIG. 17B, in response to a user input for a lower window 1725 other than a window disposed on the topmost layer, the electronic device 101 may execute a speech recognition function instead of displaying an input interface, as illustrated in 1700d. While the speech recognition feature is being executed, the electronic device 101 may output a graphic visual effect 1740 indicating a speech input state. For example, the electronic device 101 may use speech as an input while maintaining the size of the current window 1725 and without covering other screens being worked on.

FIG. 17C illustrates a screen on which a speech recognition function is executed when an input target for which user input for an input item and text displayed in a size smaller than a specified size is possible is selected according to an embodiment of the disclosure.

Referring to 1700e of FIG. 17C, the electronic device 101 may make selection for text input by focusing on a window 1750 disposed at a long distance in the virtual reality space by using a pointer. In response to the selection, the electronic device 101 may identify the depth of the window 1750, and when the depth of the window 1750 is greater than a specified depth and the window 1750 is displayed in a size or ratio equal to or smaller than a specified size or a specified ratio, the electronic device 101 may execute the speech recognition function instead of displaying the input interface, as illustrated in 1700f. During the execution of the speech recognition function, the electronic device 101 may output a graphic visual effect 1760 indicating that a speech input state.

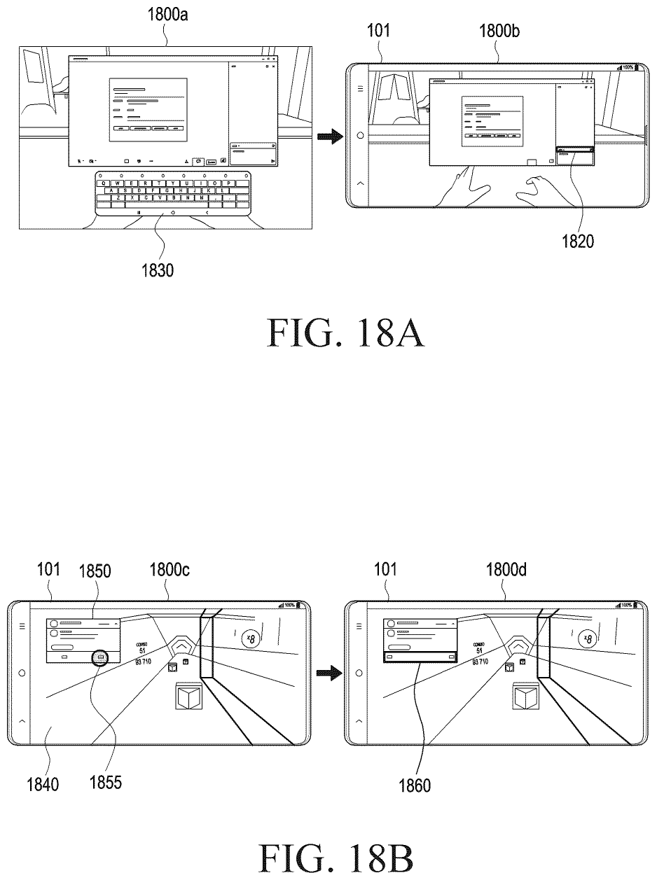

FIG. 18A illustrates a screen on which a speech recognition function is executed when a virtual reality space of an external electronic device is moved and executed in an electronic device according to an embodiment of the disclosure.

Referring to 1800a of FIG. 18A, a case in which a video conferencing application is being executed in a virtual reality space in an external electronic device is illustrated. Here, the size of a display of the external electronic device may be greater than the size of the display of the electronic device 101. If a user input for message generation is detected during a video conference, the external electronic device having the display larger than the display of the electronic device 101 may display an input interface 1830 as illustrated in 1800a. In an embodiment, when the external electronic device is a display device such as a television (TV), a touch function is not provided, and thus if there is a keyboard connected to the external electronic device through Bluetooth communication prior to displaying the input interface 1830, the input interface 1830 may be displayed as illustrated in 1800a. In case that there is no input device (e.g., a keyboard) connected to the external electronic device, the external electronic device may execute the speech recognition function instead of displaying the input interface 1830.

On the other hand, in case of a user who is using the electronic device 101, if a user input for message generation is detected, it may be identified whether a display ratio of the input interface to the entire screen is equal to or greater than a threshold ratio. In case that the input interface has a size equal to or greater than the threshold ratio, the display of the input interface may cover most of the entire screen, and thus the electronic device 101 may execute the speech recognition function as shown in 1800b. Accordingly, the electronic device 101 may output a graphical visual effect 1820 indicating that speech input is possible.

FIG. 18B illustrates a screen on which a speech recognition function for text input is executed when a situation requiring text input occurs in a virtual reality space of an electronic device according to an embodiment of the disclosure.

Referring to 1800c of FIG. 18B, the electronic device 101 may detect a user selection 1855 of an application 1850 for providing a text-related function while an application 1840 is being executed in a virtual reality space. In response to the user selection 1855 of the application 1850 that provides the text-related function, the electronic device 101 may execute a speech recognition function as illustrated in 1800d so that the execution screen of the application 1840 in the virtual reality space is not covered by the display of the input interface. Accordingly, the electronic device 101 may output a graphic visual effect 1860 that indicates a state in which speech input is possible.

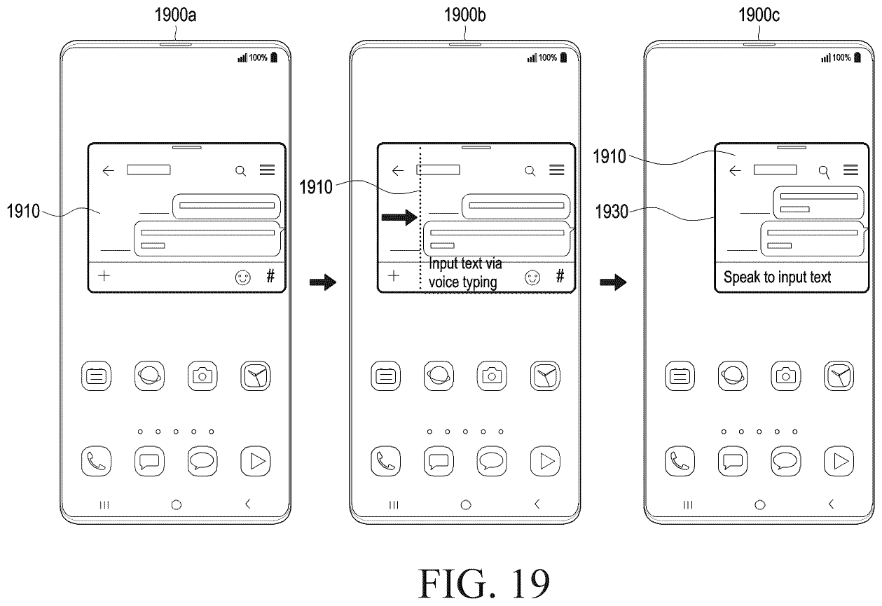

FIG. 19 illustrates a screen on which a speech recognition function is executed when a size of an input target for which user input for an input item and text is possible is reduced to a threshold size according to an embodiment of the disclosure.

Referring to 1900a of FIG. 19, an application 1910 that provides a text-related function may be resizable according to a user input. In response to a user input for adjusting the size of the application 1910, as in 1900b, the electronic device 101 may gradually reduce the size of the application 1910, i.e., the window size. The electronic device 101 may identify whether the size of the application 1910 adjusted according to the user input reaches a threshold size. In response to the size of the application 1910 reaching the threshold size, the electronic device 101 may output feedback indicating that the speech recognition function is executed. In addition, the electronic device 101 may turn on the microphone and execute a speech recognition function in response to a user selection (e.g., a touch input) with respect to a text input area, as illustrated in 1900c. As the speech recognition function is executed, the electronic device 101 may output a guiding message indicating that text is to be input by speech, and may indicate that speech input is possible by using a graphic visual effect 1930 of a method in which a color of the border of the application 1910 is changed.

According to an embodiment, an electronic device changes and provides an input method for inputting an input item including text according to various situations so that a user can more easily use the functions of the electronic device, whereby the user's convenience and satisfaction can be increased.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, a non-transitory storage medium stores instructions configured to, when executed by at least one processor 120 or 320 of an electronic device 101, cause the electronic device to perform at least one operation, and the at least one operation may include displaying a window of an application. According to an embodiment, the at least one operation may include detecting a user selection for displaying an input interface for the window. According to an embodiment, the at least one operation may include comparing the size of the window or the input interface with a specified size in response to the user selection. According to an embodiment, the at least one operation may include executing one of a display of the input interface or a speech recognition function, based on a result of the comparison.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
at least one processor operatively connected to the display and the memory,
wherein the instructions, when executed by the at least one processor individually or collectively, cause the electronic device to:
display a window of an application,
detect a user selection for displaying an input interface for the window,
in response to the user selection, compare a size of the window or the input interface with a specified size, and
execute one of a display of the input interface or a voice recognition function according to a result of the comparison.

2. The electronic device of claim 1, wherein the instructions, when executed by the at least one processor individually or collectively, further cause the electronic device to:
execute the voice recognition function when the size of the input interface is greater than the specified size.

3. The electronic device of claim 2, wherein the instructions, when executed by the at least one processor individually or collectively, further cause the electronic device to:
execute the voice recognition function when the size of the input interface is greater than the specified size while a window of a specified application different from the application is displayed.

4. The electronic device of claim 3, wherein the specified application includes at least one of a video application, a game application, or a video call application.

5. The electronic device of claim 4, wherein the instructions, when executed by the at least one processor individually or collectively, further cause the electronic device to:
execute the voice recognition function when the size of the window is less than the specified size.

6. The electronic device of claim 5, wherein the instructions, when executed by the at least one processor individually or collectively, further cause the electronic device to:
in response to a user input for adjusting a size of the window, identify whether the size of the window, which is adjusted according to the user input, reaches a threshold size, and
in response to the size of the window reaching the threshold size, output feedback regarding the execution of the voice recognition function.

7. The electronic device of claim 6, wherein the instructions, when executed by the at least one processor individually or collectively, further cause the electronic device to:
display text corresponding to a voice input within the window by using the voice recognition function.

8. The electronic device of claim 7, wherein the instructions, when executed by the at least one processor individually or collectively, further cause the electronic device to:
display the window of the application in a virtual reality space.

9. The electronic device of claim 8, wherein the instructions, when executed by the at least one processor individually or collectively, further cause the electronic device to:
execute the voice recognition function when the window of the application displayed in a virtual reality space is covered by a virtual object.

10. The electronic device of claim 9, wherein the instructions, when executed by the at least one processor individually or collectively, further cause the electronic device to:
identify a depth of the window of the application displayed in a virtual reality space, and
execute the voice recognition function when the size of the window is smaller than the specified size and the identified depth is greater than a specified depth.

11. A method for executing a voice recognition function performed by an electronic device, the method comprising:
displaying a window of an application;
detecting a user selection for displaying an input interface for the window;
in response to the user selection, comparing a size of the window or the input interface with a specified size; and
based on a result of the comparison, executing one of a display of the input interface or the voice recognition function.

12. The method of claim 11, wherein the executing of one of the display of the input interface or the voice recognition function comprises executing the voice recognition function in case that the size of the input interface is greater than the specified size.

13. The method of claim 12, wherein the executing of one of the display of the input interface or the voice recognition function comprises:
executing the voice recognition function in case that the size of the input interface is greater than the specified size in a state where a window of a specified application different from the application is displayed; and
displaying text corresponding to input voice in the window by using the voice recognition function.

14. The method of claim 13, wherein the specified application comprises at least one of a video application, a game application, or a video call application.

15. The method of claim 14, further comprising:
executing the voice recognition function when the size of the window is less than the specified size.

16. The method of claim 15, further comprising:
in response to a user input for adjusting a size of the window, identifying whether the size of the window, which is adjusted according to the user input, reaches a threshold size; and
in response to the size of the window reaching the threshold size, outputting feedback regarding the execution of the voice recognition function.

17. The method of claim 16, further comprising:
displaying the window of the application in a virtual reality space.

18. The method of claim 17, further comprising:
executing the voice recognition function when the window of the application displayed in a virtual reality space is covered by a virtual object.

19. The method of claim 18, further comprising:
identifying a depth of the window of the application displayed in a virtual reality space; and
executing the voice recognition function when the size of the window is smaller than the specified size and the identified depth is greater than a specified depth.

20. A non-transitory computer-readable storage medium storing instructions, that, when executed by at least one processor of an electronic device individually or collectively, cause the electronic device to perform operations, the operations comprising:
displaying a window of an application;
detecting a user selection for displaying an input interface for the window;
in response to the user selection, comparing a size of the window or the input interface with a specified size; and
based on a result of the comparison, executing one of a display of the input interface or a voice recognition function.
